(19) United States
(12) Patent Application Publication
(10) Pub. No.: US 2009/0165753 A1
(43) Pub. Date: Jul. 2, 2009

(54) Delivery Unit

(75) Inventors: Walter Froehlich, Frankurt am Main (DE); Günter Rauchhaus, Raunheim (DE); Thomas Sippel, Fulda (DE)

Correspondence Address: COHEN, PONTANI, LIEBERMAN & PAVANE LLP, 551 FIFTH AVENUE, SUITE 1210, NEW YORK, NY, 10176, US

(73) Assignee: Continental Automotive GmbH, Hannover (DE)

(21) Appl. No.: 12/300,443

(22) PCT Filed: Jan. 30, 2008
(86) PCT No.: PCT/EP2008/051149

§ 371 Date: Nov. 11, 2008

(30) Foreign Application Priority Data
Feb. 13, 2007 (DE) 102007007597.0
Jan. 21, 2008 (DE) 102008005358.9

(51) Int. Cl. F02M 37/10

(52) U.S. Cl. 123/509

(57) ABSTRACT

The invention relates to a delivery unit for delivering fuel from a fuel reservoir (2) to an internal combustion engine of a motor vehicle. Said delivery unit comprises a fuel pump which is arranged in a swirl pot (4), and a flange (3) which closes an opening (5) of the fuel reservoir, the swirl pot being connected to the flange via at least two supporting elements (6). The supporting elements consist of a fuel-resistant plastic material.

The subject matter of the invention is a delivery unit for delivering fuel from a fuel tank to an internal combustion engine of a motor vehicle, with a fuel pump which is arranged in a swirl pot, and a flange which closes an opening of the fuel tank, wherein the swirl pot is connected to the flange via at least two supporting elements.

Delivery units of this type have long been known and are therefore prior art. It is known in this respect to design the supporting elements as metal tubes. The supporting elements are pressed into receiving bushings in the flange by means of an interference fit. The circumference of the swirl pot has corresponding guides in which the supporting elements are guided in a longitudinally displaceable manner. Spiral springs which surround the supporting elements and are supported at one end on the respective supporting element or on the flange and at the other end on the swirl pot cause the swirl pot to be prestressed toward the bottom of the fuel tank. Owing to specified safety regulations, metal parts having a capacitance of greater than 3 pF have to be protected against static charges. This means that the metal tubes have to be grounded, thus increasing the outlay on the delivery unit.

The present invention is therefore based on the object of providing a delivery unit at a low outlay.

The object is achieved in that the supporting elements consist of a fuel-resistant plastic material.

The selection of a fuel-resistant plastic material as the material for the supporting elements means that the latter have a capacitance of less than 3 pF. In accordance with the specified safety regulations, said components therefore do not additionally have to be protected against static charges. Grounding of the supporting elements can therefore be omitted, thus reducing the outlay on the delivery unit.

Polyoxymethylene or polyamide have proven worthwhile as plastic materials for use in fuel-containing environments and are furthermore distinguished by being easily processed, in particular by means of injection molding.

To further increase the protection against electrostatic charges, or the safe dissipation thereof, it is advantageous if the plastic material for the supporting elements contains admixtures of carbon in the form of soot or nanotubes.

If the swirl pot and in particular the guides for the supporting elements likewise consist of plastic, an undesirable production of noise may occur during movement of the supporting elements in the guides. Such a production of noise is avoided if the plastic material for the supporting elements contains admixtures of chalk.

In order to obtain adequate stability for the supporting elements with small cross-sectional dimensions, it has proven advantageous to provide the supporting elements with a profiling running along their longitudinal axis.

Very varied shapes are conceivable as the profiles. However, solid profiles have proven worthwhile in addition to hollow profiles. According to an advantageous refinement, a low use of material with adequate strength is achieved with supporting elements which have a profiling designed as webs.

The fastening of the supporting elements proves particularly simple if the supporting elements, at their end facing the swirl pot, have at least one radially outwardly directed latching hook. When the supporting elements are first introduced into the guides of the swirl pot, the at least one latching hook is reversibly deformed until it has passed the guide. It subsequently moves into its initial position, as a result of which the respective supporting element is secured against release from the guide. The supporting elements can thereby be fitted in a particularly simple manner.

The invention is explained in more detail using an exemplary embodiment. In the figures

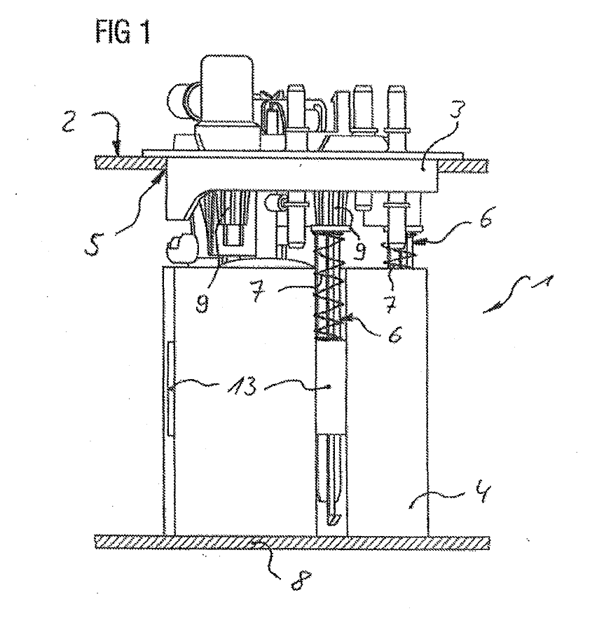

FIG. 1 shows a delivery unit according to the invention, and

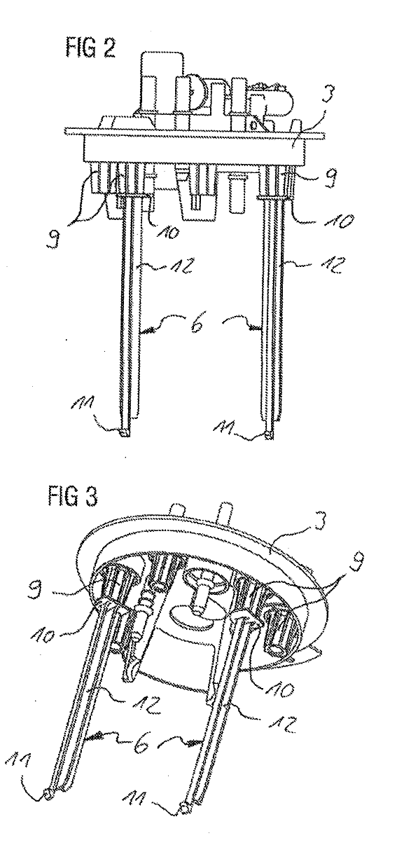

FIGS. 2, 3 show the flange of the delivery unit according to FIG. 1.

FIG. 1 shows a delivery unit 1 for use in a fuel tank 2 of a motor vehicle. The delivery unit 1 comprises a flange 3 and a swirl pot 4. The flange 3 is designed in such a manner that it closes an opening 5 of the fuel tank 2, through which opening the delivery unit 1 is inserted in the fuel tank 2. A fuel pump (not illustrated) is arranged in the swirl pot 4, said fuel pump delivering fuel from the swirl pot 4 through the flange 3 to an internal combustion engine (not illustrated) of the motor vehicle. Guides 13 in which a respective supporting element 6 engages are arranged on the circumference of the swirl pot 4. Each supporting element 6 is surrounded by a helical spring 7. The helical springs 7 are supported on the flange 3 and on the guides 5 and thereby bring about a prestressing of the swirl pot 4 toward the bottom 8 of the fuel tank 2.

FIGS. 2 and 3 show the flange 3 with the supporting elements 6. For the fastening of the supporting elements 6, the flange has bushings 9 into which the supporting elements 6 are pressed. In the upper region, the supporting elements 6 each have a collar 10 which delimits the insertion depth of the supporting elements 6. At the same time, it is thereby ensured that each supporting element 6 is pressed in to the same depth and therefore the swirl pot is prestressed by the helical springs 7 toward all of the latching hooks 11 at the lower end of the supporting elements 6 before the delivery unit 1 is fitted in the fuel tank 2. The supporting elements 6 consist of polyamide. To avoid electrostatic charges, carbon in the form of soot is admixed. For mechanical reinforcement, the supporting elements 6 have webs 12 running axially. Furthermore, the webs 11 form a good guide for the helical springs.

1-7. (canceled)

8. A fuel delivery unit for delivering fuel from a fuel tank to an internal combustion engine, the fuel delivery unit comprising:
a swirl pot having at least two support guides;
a fuel pump which is arranged in the swirl pot;
a flange adapted to an opening of the fuel tank, the flange comprising at least two bushings; and
at least two fuel-resistant plastic supporting elements, the support elements each having a first end adapted to mount in one of the bushings, the at least two supporting elements further configured to mate with the support guides,
wherein the swirl pot is attached to the flange via the supporting elements.

9. The fuel delivery unit according to claim 8, wherein the at least two supporting elements are at least one of polyoxymethylene and polyamide.

10. The fuel delivery unit according to claims 8, wherein the at least two supporting elements contain admixtures of carbon.

11. The fuel delivery unit according to claim 8, wherein the at least two supporting elements consist of a chalk-filled plastic material.

12. The fuel delivery unit according to claim 8, wherein each of the at least two supporting elements have a profile on its longitudinal axis.

13. The fuel delivery unit according to claim 12, wherein the at least two supporting elements have a profile configured as a web.

14. The fuel delivery unit according to claim 8, wherein each of the at least two supporting elements further comprises at least one latching hook facing the swirl pot at a second end of the supporting elements.

15. The fuel delivery unit according to claim 9, wherein each of the at least two supporting elements contain admixtures of carbon.

16. The fuel delivery unit according to claim 10, wherein the carbon is at least one of soot or nanotubes.

17. The fuel delivery unit according to claim 15, wherein the carbon is at least one of soot or nanotubes.

18. The fuel delivery unit according to claim 14, wherein the at least one latching hook is directed radially outwardly.

19. The fuel delivery unit according to claim 8, wherein the at least two supporting elements have a capacitance of less than 3 pF.

20. The fuel delivery unit according to claim 8, further comprising a helical spring surrounding each of the at least two supporting elements.

21. The fuel delivery unit according to claim 20, wherein each of the at least two supporting elements further comprises a collar at the first end of the supporting element, the collar defining an insertion depth of the supporting element into the bushing and supporting one end of the helical spring.

22. The fuel delivery unit according to claim 21, wherein the helical spring is supported between the support guide and collar.

23. The fuel delivery unit according to claim 12, wherein at least one of the two supporting elements has a profile configured as at least one of a solid rod and a hollow tube.

24. The fuel delivery unit according to claim 22, wherein the helical spring presses the swirl pot towards a bottom of the fuel tank.
